(19) United States
(12) Patent Application Publication
(10) Pub. No.: US 2007/0174064 A1
(43) Pub. Date: Jul. 26, 2007

(54) Multiple tickets for receiving content

(75) Inventor: Franklin Selgert, Berkel En Rodenrijs (NL)

Correspondence Address: MICHAELSON & ASSOCIATES, P.O. BOX 8489, RED BANK, NJ, 07701, US

(73) Assignee: KONINKLIJKE KPN N.V.

(21) Appl. No.: 10/585,810

(22) PCT Filed: Feb. 28, 2005
(86) PCT No.: PCT/EP05/02163

§ 371 Date: Jul. 13, 2006

Related U.S. Application Data
(60) Provisional application No. 60/548,812, filed on Feb. 27, 2004.

(51) Int. Cl. G06Q 99/00

(52) U.S. Cl. 705/1

(57) ABSTRACT

A method is disclosed for accessing content via a device (30) whereby a ticket (20) is used that can be sent to the device (30) and whereby a validation count field (26) is comprised by the ticket (20) that is arranged for being decreased each time that content is accessed. If the content is stored on the device (30) after this content has been received by the device (30) it is possible to let the user view or use this content without having to send this content to the device (30) again. In such a much more efficient procedure, the ticket (20) can be validated each time the user views or uses the stored content in stead of validating the ticket (20) each time the content is received by the device (30).

### FIELD OF THE INVENTION

The present invention relates to a method of using tickets on smart cards, and to smart cards in which tickets are stored. In particular, the present invention relates to the secure storing, validating and verifying of multiple tickets on smart cards, multiple tickets being tickets that may be used more than once.

### BACKGROUND OF THE INVENTION

European Patent Application EP 0 829 828 describes a smart card which allows tickets to be efficiently stored, whereby the smart card comprises an integrated circuit having a processor and a memory, the memory comprising tickets, a ticket comprising an entitlement field for storing data relating to the entitlement of the ticket, and a validation field for storing data relating to the validity of the ticket. The ticket on the smart card comprises a validation count field for registering the number of times the ticket may be validated.

By providing a validation count field, it is possible to validate the same ticket more than once while strictly controlling the number of times the ticket may be used. As a multiple ticket of this type requires hardly more memory space than a regular ticket, a very efficient memory use is achieved.

Every time a ticket is used, the validation count field is decreased. Decreasing the validation count field can be done by a terminal. For instance, the terminal resides at a location in a theater where the terminal is used for validating the ticket. When a person wants to enter the theatre he has to let the ticket be validated by the terminal, after which the validation count field is decreased. However, the prior art does not provide a procedure for accessing content via a ticket.

### AIM OF THE INVENTION

It is an object of the invention to eliminate the drawbacks of the prior art and to provide a method for making accessible content using a ticket.

### SUMMARY

In accordance with this invention a method is disclosed for:

using a ticket for accessing content whereby the ticket can be sent to a device and whereby a validation count field comprised by the ticket is arranged for being decreased each time the content is accessed.

In a first aspect of the invention is disclosed that a ticket can be sent to a device of a user. With the ticket the user may be able to receive content from a content provider. The content can be any kind of information, video- or audio content, or any kind of multi-media content. Examples of content are weather information, ringtones, video', person-to-person communication, and one-to-many communication such as broadcasted content. The content can also be content that is received by the user when a service is provided to the user by the content provider. The device can be a mobile device, such as a mobile telephone, although other device types are not excluded in this invention. The ticket can be a digital rights object that enables the user of the device to perform an action according to certain rights. The ticket can be stored in the device for instance in a memory means. The memory means may be part of a SIM-card, although this is not necessary according to the present invention.

After the content is received by the device the user can view or use the content. A validation count field that is comprised by the ticket is decreased every time the user uses or views the content. If the user wants to view or use the same content again, the content provider does not have to send again this content to the device if the content has been sent to the device earlier. Also if the content already resides at the device, the content can be accessed by the user whereby the ticket is validated each time the content is used or viewed by the user.

The content is sent to the device by the content provider via a network that is operated by a communication provider. It may be the case that the party that issues the ticket, i.e. sends the ticket to the device, is the same party that provides the content. Because the ticket and the content originate then from the same party the security measures to have to be taken are relatively simple compared to the situation whereby the content and the ticket are provided by two different parties.

A ticket may comprise different fields such as a validation field and a price field. However a ticket may also comprise less fields, or more fields of the same type, e.g. two price fields. It may also be the case that for each application type (such as gambling, viewing previews, etc.) there is another type of ticket. A ticket may then only be used for a specific application type.

### BRIEF DESCRIPTION OF THE DRAWING FIGURE

The foregoing aspects and many of the attendant advantages of this invention will become better understood by reference to the following detailed description, when taken in conjunction with the accompanying drawing, wherein:

FIG. 1 is a block diagram illustrating the concept issuing and using a ticket (20).

FIG. 2 schematically shows the structure of a ticket (20).

### EXEMPLARY EMBODIMENTS

For the purpose of teaching of the invention, preferred embodiments of the method and devices of the invention are described in the sequel. It will be apparent to the person skilled in the art that other alternative and equivalent embodiments of the invention can be conceived and reduced to practice without departing form the true spirit of the invention, the scope of the invention being limited only by the appended claims as finally granted.

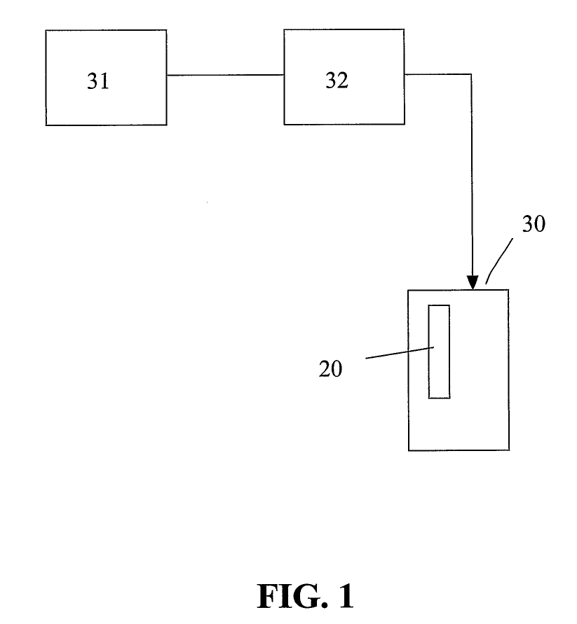

In FIG. 1 the concept is depicted whereby a ticket (20) can be sent to a device (30) of a user. With the ticket (20) the user may be able to receive content from a content provider (31). The device (30) can be a mobile device, such as a mobile telephone, although other device types are not excluded in this invention. The ticket (20) can be stored in the device (30) for instance in a memory means. The memory means may be part of a SIM-card, although this is not necessary according to the present invention. According the present invention it is also identified that the content provider (31) also can issue the ticket (20). Further, it is identified according to this invention that the ticket (20) can be validated each time the user views or uses content that already resides on the device (30).

The content can be any kind of information, video- or audio content, or any kind of multi-media content. Examples of content are weather information, ringtones, video', person-to-person communication, and one-to-many communication such as broadcasted content. The content can also be content that is received by the user when a service is provided to the user by the content provider (31).

When a ticket (20) is used for accessing content, the following can take place. The content provider (31) issues the ticket (20) by sending the ticket (20) to the device (30) via a network of a communication provider (32). The ticket (20) can be a digital rights object that enables the user of the device (30) to perform an action according to certain rights. The network can be a mobile network, although this invention is not limited to situations where a mobile network is used. When the user wants to receive content, the content is sent by the content provider (31) to the device (30), after which the validation count field (26) of the ticket (20) residing at the device (30) is decreased. After the content is received by the device (30), the user can view or use the content.

If the user wants to view or use the same content again, the content provider (31) sends again this content to the device (30). This is not an efficient procedure since the same content has been sent already to the device (30). If the content is stored on the device (30) after this content has been received by the device (30) for the first time, it is possible to let the user view or use this content without having to send this content to the device (30) again. In such a much more efficient procedure, the ticket (20) can be validated each time the user views or uses the stored content in stead of validating the ticket (20) each time the content is received by the device (30).

In order to use the ticket (20) in such an enhanced procedure, a local- or network key generator may be used for activating the ticket (20) after the ticket (20) has been issued. If security measures are taken during the issuing of the ticket (20), the security measures relating to the validation of the ticket (20) residing on the device (30) can be relatively simple.

In an embodiment of the present invention the party that issues the ticket (20) and the party that provides the content can be the same content provider (31). In such a case the ticket (20) and the content originate from the same party, which simplifies the security measures to be taken. The ticket (20) can be restricted to be used for accessing only content provided by the content provider (31) that issued the ticket (20).

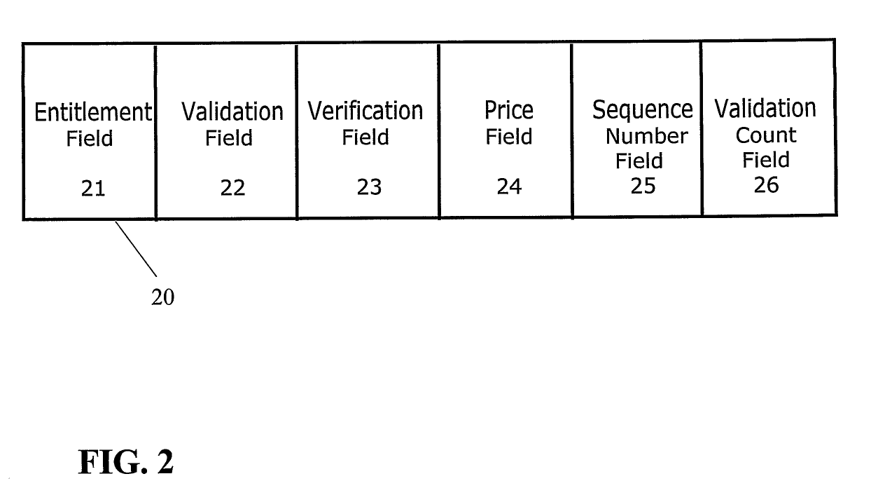

In FIG. 2, As an example, a content provider dedicated ticket may comprise: an entitlement field (21), a validation field (22), a verification field (23), a price field (24), a sequence number field (25), and a validation count field (26). The identity of the content provider (31) that issued the ticket (20) can be stored in the entitlement field (21). In practice, a ticket (20) may comprise additional fields to those that are mentioned before. Also, a ticket (20) according to the present invention may comprise less fields, or more fields of the same type, e.g. two verification fields.

It may also be the case that for each application type (such as gambling, viewing previews, etc.) there is another type of ticket. A ticket (20) may then only be used for that type of applications where it is intended for.

1. Method for using a ticket (20) for accessing content whereby the ticket (20) can be sent to a device (30) and whereby a validation count field (26) comprised by the ticket (20) is arranged for being decreased each time the content is accessed.

2. Method according to claim 1 whereby the ticket (20) comprises a price field (24) for storing pricing information.

3. Method according to claim 2, whereby the pricing information is related to the price of a ticket (20).

4. Method according to claim 2, whereby the pricing information is related to the price of a single use of the ticket (20).

5. Method according to claim 1, whereby the content is accessed by downloading the content to the device (30).

6. Method according to claim 1, whereby the content is accessed by obtaining it from the device (30).

7. Method according to claim 1, whereby a content provider (31) issues the ticket (20) and provides the content where the ticket (20) is used for.

8. Method according to claim 1, whereby the ticket (20) only can be used for a specific category of content.
